(19) United States
(12) Patent Application Publication
(10) Pub. No.: US 2002/0005987 A1
(43) Pub. Date: Jan. 17, 2002

(54) Polarization beam splitter or combiner

(76) Inventors: Gonzalo Wills, Ottawa (CA); Pierre D. Wall, Ottawa (CA)

Correspondence Address: JDS UNIPHASE CORPORATION, INTELLECTUAL PROPERTY DEPARTMENT, 570 WEST HUNT CLUB ROAD, NEPEAN, ONTARIO, K2G 5W8, CA

(21) Appl. No.: 09/731,908

(22) Filed: Dec. 8, 2000

Related U.S. Application Data
(60) Provisional application No. 60/218,136, filed on Jul. 14, 2000.

(51) Int. Cl. G02B 5/30; G02B 27/28

(52) U.S. Cl. 359/497; 359/484; 359/494; 359/495; 359/499

(57) ABSTRACT

This invention relates to elements such as birefringent crystals, which are used to separate an input beam into two orthogonally polarized sub-beams or to combine two orthogonally polarized beams into a single beam. The optical device lessens or obviates the optical path length difference encountered in prior art devices and provides a polarization beam splitter/combiner that has substantially same optical path lengths for two split or combined beams propagating therethrough. Furthermore, the device can be operated such that it provides isolation in a reverse direction of operation. The polarization beam splitter/combiner in accordance with the invention has a first uniaxial crystal having an o-ray path and an e-ray path and having the first port disposed at an end face thereof; a second uniaxial crystal having an o-ray path and an e-ray path, the e-ray path of the second uniaxial crystal being optically coupled with the o-ray path of the first uniaxial crystal and the o-ray path of the second uniaxial crystal being optically coupled with the e-ray path of the first uniaxial crystal. Alternatively, the axis of the second crystal is aligned in such a manner that the o-ray path is retarded by an extraordinary index of refraction of the crystal and the e-ray path is retarded by an ordinary index of refraction to equalize the optical path lengths.

### FIELD OF THE INVENTION

This invention relates generally to elements such as uniaxial crystals, which are used to separate an input beam into two orthogonally polarized sub-beams or to combine two orthogonally polarized beams into a single beam.

### BACKGROUND OF THE INVENTION

Polarization independent devices such as optical circulators and isolators generally require separating the input beam having an unknown polarization state, into two orthogonally polarized sub-beams. These sub-beams are routed through the isolating elements of the device such as reciprocal and non-reciprocal rotators and are combined at an output end. However, if the beams are launched in a backwards direction non-reciprocal elements ensure that the light does not couple back into the input port. Rutile crystals are well known for the purpose of separating an input beam into two orthogonally polarized sub-beams thereby serving as a polarization beam splitter, or operated in an opposite direction as a polarization beam combiner. Within this specification the term polarization beam splitter is used however it should be understood, that the same device can serve as a polarization beam combiner operated in reverse.

It has been typical, for light propagating within these crystals to be collimated, most often by a graded index (GRIN) lens. In this instance a relatively large crystal is required to ensure separation of two beams which have diameters typically as large as 350 μm. However, recently, it was discovered that very small crystals, about 1/50^{th} the size of conventional crystals could be used with a non-collimated beam; using such small crystals substantially lessens the cost of manufacturing an optical circulator or an optical isolator.

Many polarizers and polarizing beam splitters that separate an input from a beam into two orthogonal polarizations or that combine two orthogonal polarizations into one output beam are known to the art. These include a Glan-Thompson polarizer, which is a block of birefringent material cut into prisms and then cemented together, that acts by reflecting one polarization component at the cement interface and by transmitting the other. Another polarizer is a Glan-Taylor polarizer which is similar to the Glan-Thompson polarizer but uses an air space instead of cement to separate polarization components. The Wollaston, Rochon and Senarmont beam-splitters separate polarization components by transmitting the components through an interface.

However, one disadvantage of all of these prior art polarization beam splitters/combiners is that there is a difference in optical path length for the two separated orthogonal polarizations traveling through a birefringent crystal. Using birefringent crystals where the light propagating therethrough is not collimated, leads to an increase in insertion loss due to a defocusing or a need to compensate for the path length difference. The sub-beams follow a slow axis and a fast axis which corresponds to this difference in optical path length shown in FIG. 1. In this figure an optical fibre 10 is shown having its end optically coupled with a rutile crystal 22 via a lens 12. It is typical after separating the beam into its two orthogonal polarization states to couple the light into two fibre ends (not shown). However, as can be seen from FIG. 1, the two focus spots do not lie on a same focal plane. This is due to the optical path length difference for the e-ray and the o-ray through the crystal 22. Generally pairs of optical fibres are held securely in a fixed manner in an optical fibre tube. In this instance if such a tube was used and disposed at one of the spots 14a or 14b, the other of the spots would not be in focus at the tube end, and light from either the e-ray or o-ray path would couple poorly.

It is an object of this invention to provide a device, which lessens or obviates this optical path length difference.

It is an object of this invention to provide a polarization beam splitter/combiner that has substantially same optical path lengths for two split or combined beams propagating therethrough.

Another object of this invention is to provide a polarization beam splitter/combiner that can be operated such that it provides isolation in a reverse direction of operation. For example it is an object of the invention to provide a polarization beam splitter that provides isolation from signals propagating in a backwards direction; or alternatively, it is an object of the invention to provide a polarization beam combiner that provides isolation from signals propagating in a reverse direction.

### SUMMARY OF THE INVENTION

In accordance with the invention there is provided, a polarization beam splitter/combiner comprising:

a first port for launching a beam of light into the polarization beam splitter/combiner in a forward direction or for receiving a beam of light from the polarization beam splitter/combiner in a reverse direction;

a first uniaxial crystal having an o-ray path and an e-ray path and having the first port optically coupled to an end face thereof;

a second uniaxial crystal having an e-ray path and an o-ray path such that the e-ray path of the second uniaxial crystal is optically coupled with the o-ray path of the first uniaxial crystal and the o-ray path of the second uniaxial crystal is optically coupled with the e-ray path of the first uniaxial crystal; and

a second and a third port optically coupled to an end face of the second uniaxial crystal for one of receiving a first beam of a first polarization state and a second beam of a second orthogonal polarization state in the forward direction and for launching the first beam of the first polarization state and the second beam of the second orthogonal polarization state into the polarization beam splitter/combiner in the reverse direction, each of the second and the third ports being optically coupled with a polarization maintaining waveguide,

wherein the first beam of the first polarization state and the second beam of the second orthogonal polarization state have a substantially same optical path length.

In accordance with the invention it is provided, wherein the first uniaxial crystal and the second uniaxial crystal are optically coupled to provide equal optical and physical path lengths.

In accordance with the invention it is alternatively provided, wherein an axis of the second crystal is aligned in such a manner that the o-ray path is retarded by an extraordinary index of refraction of the crystal and the e-ray path is retarded by an ordinary index of refraction to equalize the optical path lengths.

In accordance with another embodiment of the present invention, the first and the second uniaxial crystal are directly coupled and an orientation of the optical axes of the first uniaxial crystal and the second uniaxial crystal is such that the e-ray path of the second uniaxial crystal is optically coupled with the o-ray path of the first uniaxial crystal and the o-ray path of the second uniaxial crystal is optically coupled with the e-ray path of the first uniaxial crystal.

In accordance with the invention, there is further provided, a polarization beam splitter/combiner comprising: a first port for one of launching a beam of light into the polarization beam splitter/combiner in a forward direction and for receiving a beam of light from the polarization beam splitter/combiner in a reverse direction; a first uniaxial crystal having an o-ray path and an e-ray path and having the first port disposed at an end face thereof; a second uniaxial crystal having an o-ray path and an e-ray path, the e-ray path of the second uniaxial crystal being optically coupled with the o-ray path of the first uniaxial crystal and the o-ray path of the second uniaxial crystal being optically coupled with the e-ray path of the first uniaxial crystal; and a second and a third port disposed at an end face of the second uniaxial crystal for one of receiving a first beam of a first polarization state and a second beam of a second orthogonal polarization state in the forward direction and for launching the first beam of the first polarization state and the second beam of the second orthogonal polarization state into the polarization beam splitter/combiner in the reverse direction, each of the second and the third ports being optically coupled with a polarization maintaining waveguide, wherein the first beam of the first polarization state and the second beam of the second orthogonal polarization state have a substantially same optical path length, and wherein output/input sub-ports at the o-ray path and the e-ray path of the first uniaxial crystal have a separation “d1” and wherein the second and the third port of the second uniaxial crystal have a separation “d2” which is substantially greater than “d1”.

In accordance with another aspect of the invention, there is provided, a method of splitting a beam of light into two orthogonally polarized sub-beams having equal path length comprising the steps of: launching the beam into a first uniaxial crystal for splitting the beam into a first and a second orthogonally polarized sub-beam, the first sub-beam traveling along an o-ray path of the first uniaxial crystal and the second sub-beam traveling along an e-ray path of the first uniaxial crystal; and coupling the first sub-beam with an e-ray path of a second uniaxial crystal and the second sub-beam with an o-ray path of the second uniaxial crystal, wherein a separation of the first and second sub-beam after passing through the first uniaxial crystal is substantially less than the separation of the first and second sub-beam after passing through the second uniaxial crystal.

### BRIEF DESCRIPTION OF THE DRAWINGS

Exemplary embodiments of the invention will now be described in conjunction with the drawings in which:

FIG. 1 is a schematic drawing illustrating a problem when two beams are launched into a birefringent crystal and follow a slow axis and a fast axis which corresponds to this difference in optical path length of the two sub-beams;

FIG. 2 is an isometric drawing illustrating an embodiment of the invention wherein components are shown separated for ease of viewing;

FIGS. 3a through 3d schematically illustrate a beam of light showing its polarization and position as it is launched into a first birefringent crystal and is passed as sub-beams through a polarization rotator and subsequently through a second birefringent crystal as shown in FIG. 2;

FIG. 4a shows a side view of the device presented in FIG. 2 wherein a half wave plate is adjacent to and contacting the birefringent crystals;

FIG. 4b shows a side view of another embodiment of the device presented in FIG. 2 having an additional Faraday rotator sandwiched between the birefringent crystals;

FIG. 5a is side view of a polarization beam splitter having a non-reciprocal rotating element providing the additional function of isolation;

FIG. 5b is a side view of a polarization beam combiner having a non-reciprocal rotating element providing the additional function of isolation;

FIG. 5c shows the polarization beam combiner of FIG. 5b having a beam of light launched into its output port;

FIGS. 6a and 6b illustrate states of polarization and position for light launched into the device shown in FIG. 5B in the forward and reverse direction respectively;

FIG. 7 shows a further embodiment of the present invention wherein the birefringent crystals are directly coupled;

FIG. 8 shows an alternative embodiment of the device presented in FIG. 7 wherein the birefringent crystals are separated by a Faraday rotator;

FIG. 9a shows a side view of the device presented in FIG. 7 wherein the crystals contact each other;

FIG. 9b shows a side view of the device presented in FIG. 8 wherein the Faraday rotator is adjacent to and contacting the crystals;

FIG. 10a shows a schematic view an alternative embodiment of the invention wherein the polarization beam splitter/combiner includes two crystals having axes oriented to provide polarization separation in the first crystal and different optical path lengths by index of refraction in the second crystal; and

FIG. 10b illustrates the states of polarization and position for light launched in to the device shown in FIG. 10a.

### DETAILED DESCRIPTION OF THE PREFERRED EMBODIMENTS

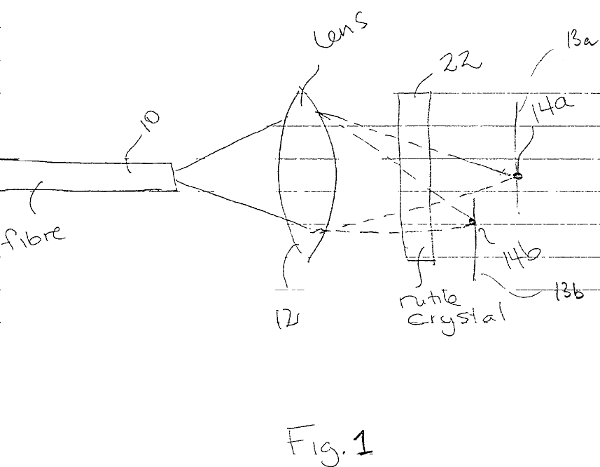

Turning now to FIG. 1, an uncollimated beam of light is shown launched from an optical fibre via a lens through a small birefringent crystal and two focus spots 14a and 14b are shown at different focal planes 13a and 13b. A focusing lens is disposed between the birefringent crystal and the two optical fibres for coupling the orthogonal spatially separated sub-beams into the fibres. Since the optical path length followed by one of the sub-beams corresponding to the o-ray is longer than the optical path followed by the other of the sub-beams corresponding to the e-ray, the focal planes for the two beams are different. This difference in focal planes leads to poor coupling if the two fibres are spaced a same distance from the lens.

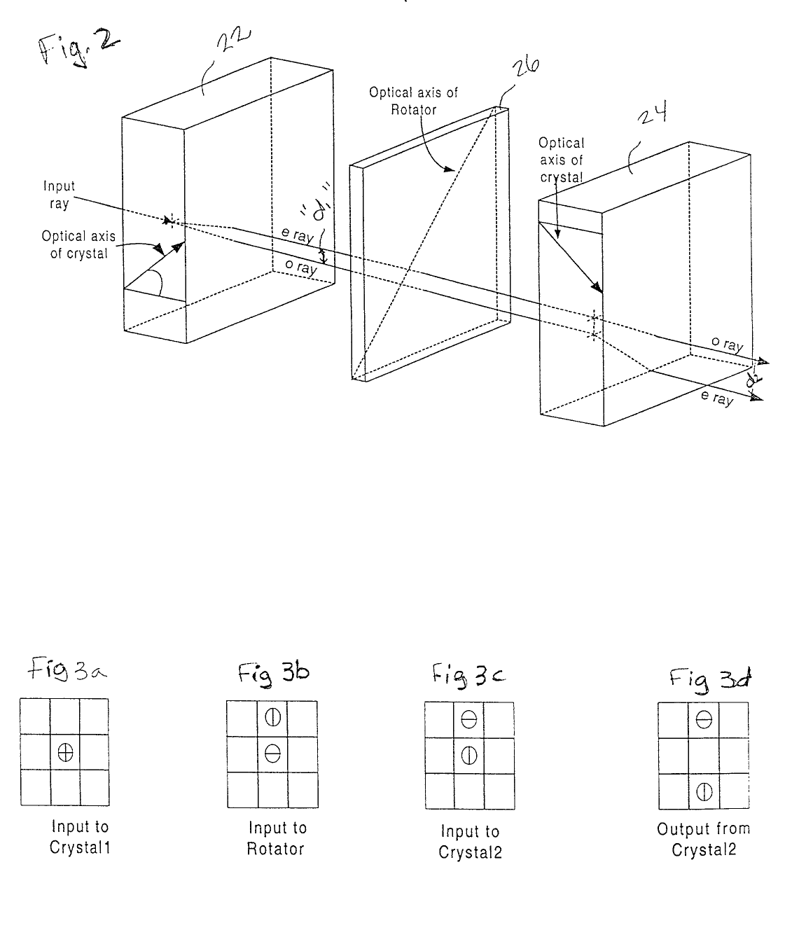

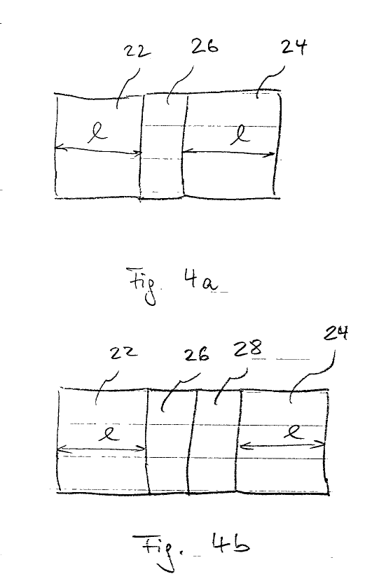

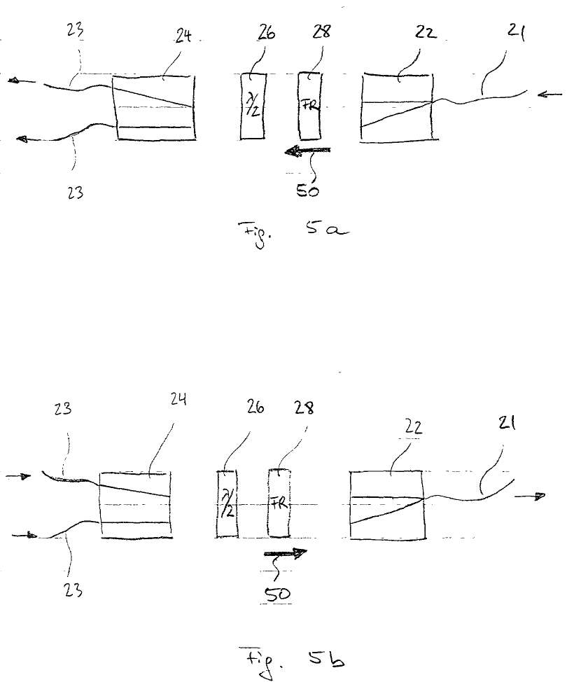

Referring now to FIG. 2, in accordance with an embodiment of the invention, a first uniaxial beam splitter/combiner in the form of a birefringent rutile crystal 22 is shown optically coupled with a second rutile crystal 24 of equal length. Alternative materials for use as a uniaxial polarization beam splitter/combiner are, for example, rutile (TiO₂), yttrium vanadate (YVO₄), magnesium fluoride (MgF₂), quartz (SiO₂), lithium niobate (LiNbO₃), and calcite (CaCO₃). A polarization rotator 26, preferably a half-wave plate, is disposed between the rutile crystals 22 and 24. Although the components 22, 24, and 26 are shown separated, having a gap therebetween, in practice they are contacting one another having a thin layer of light transmissive adhesive therebetween, and/or alternatively, an antireflective coating therebetween. Physically coupling elements of this type is well known in the art of optical circulators and isolators. FIG. 2 illustrates that the optical axes of the crystals 22 and 24 are disposed such that the o-ray path and e-ray path of the first rutile crystal 22 are coupled to the e-ray path and o-ray path of the second rutile crystal 24, respectively. The operation of the device shown in FIGS. 2 and 4 will be best understood in conjunction with FIGS. 3a through 3d.

In operation an uncollimated beam of light is launched into an input port along an optical axis of the crystal 22 at an end face thereof; the beam is shown in this state in FIG. 3a. The beam is then split into sub-beams indicated by principal rays in the figure; the e-ray follows the e-ray path of the crystal and the o-ray follows the o-ray path of the crystal as is shown in FIG. 3b. When the sub-beams, exit the crystal 22, they are separated by a distance “d1”. For clarity and simplicity, this is shown by the principal rays. These beams are then rotated by the half-wave plate 26 by 90° and appear in polarization states as shown in FIG. 3c. Thus the e-ray is presented to the second rutile crystal 24 as an o-ray after it has been rotated. The o-ray exiting the first rutile crystal 22 is presented to the second crystal as an e-ray. By so doing, the two rays, or sub-beams following the two rays, are further separated and are a distance “d2” apart as illustrated by FIG. 3d. Advantageously, it can be seen that the optical path lengths of the two sub-beams or rays diverging from the input beam or ray is substantially equal.

Advantageously this invention provides a way of coupling light that is made polarization diverse efficiently from a small crystal, without suffering from the drawbacks of unequal path lengths using uncollimated light. It is generally understood that the device in accordance with this invention is used with polarization maintaining fibre coupled to the ports disposed at an end face of the second rutile crystal 24 or to all of its ports, i.e. including the port disposed at an end face of the first crystal 22.

FIG. 4a shows a side view of the device presented in FIG. 2 wherein the half wave plate 26 is adjacent to and contacting crystals 22 and 24. A light transmissive adhesive is applied between crystals 22 and 24 and the half wave plate 26.

Two important applications of polarization beam splitters/combiners are: (a) the increase of power in one fibre by combination of two orthogonal beams from separate laser sources. In this instance the device serves as a pump combiner at the 1480 nm and 980 nm wavelengths; and (b) for de-interleaving beams of orthogonal polarization from one common input into two separate outputs.

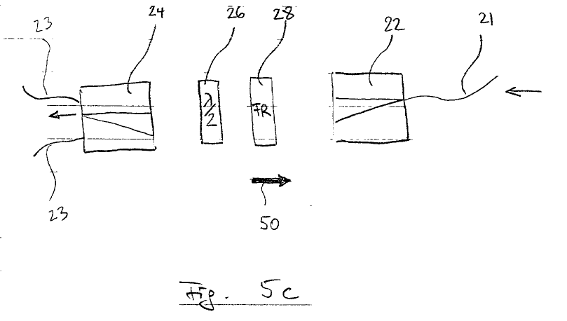

In both instances there is a generally a requirement for isolation to prevent light from traveling in the reverse direction. FIG. 4b shows a side view of another embodiment of the device presented in FIG. 2 having an additional Faraday rotator 28 sandwiched between the crystals 22 and 24. The Faraday rotator 28 and the half wave plate are also shown adjacent to and in contact with crystals 22 and 24 through the application of a light transmissive adhesive between the contacting surfaces. The operation of this embodiment is explained in more detail in conjunction with FIGS. 5a and 5b.

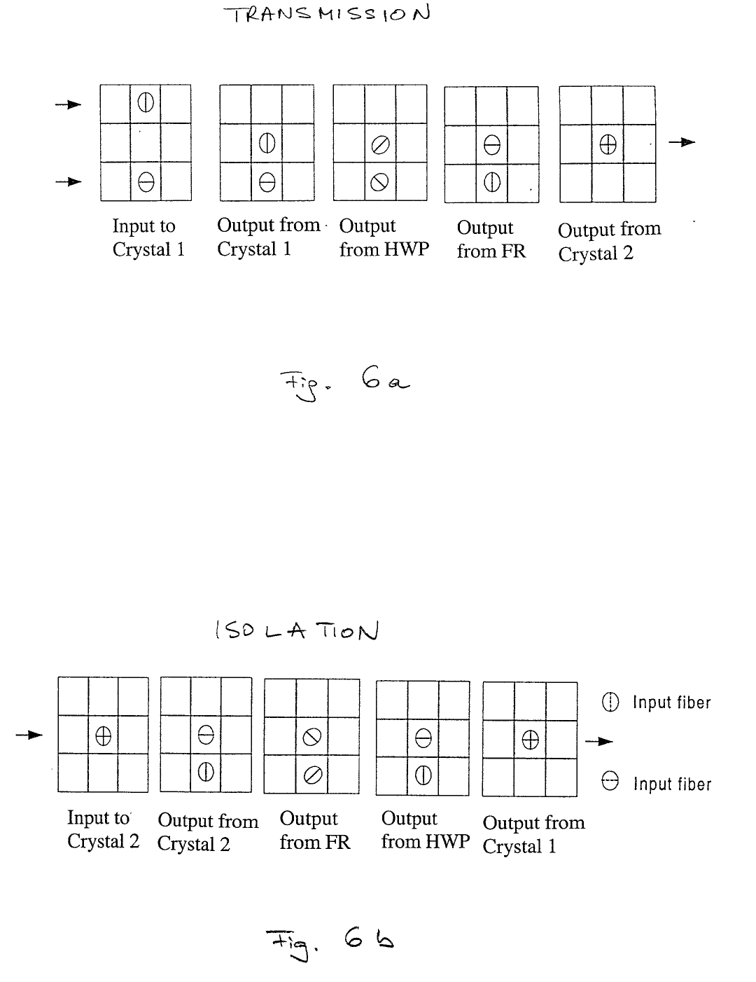

The embodiment of FIG. 4b is shown in operation in FIGS. 5a and 5b wherein isolation is provided in a polarization beam splitter in FIG. 5a, or wherein isolation is provided in a reverse direction in a polarization beam combiner in FIG. 5b by adding Faraday rotator 28. A magnet 50 is shown below the Faraday rotator and the arrowhead indicates the direction in which the rotator is driven. The device in accordance with the invention can be operated as a polarization beam combiner or polarization beam splitter depending on how the magnet is driven. FIG. 5c shows the polarization beam combiner of FIG. 5b having a beam of light launched into its output port. As can be seen, the e-ray and the o-ray are combined again by crystal 24 because of the non-reciprocal rotation by the Faraday rotator 28. The beam of light exits crystal 24 at a different location than the input ports and thus providing isolation in a reverse direction. This is explained in more detail in conjunction with FIGS. 6a and 6b.

FIGS. 6a and 6b illustrate the state of polarization for light passing through the device of FIGS. 5b and 5c in the transmission and isolation direction respectively.

The device presented in FIGS. 6a and 6b shows two birefringent crystals separated by one half wave plate with its optical axis at 22.5 degrees and one Faraday rotor which rotates a beam of light by 45 degrees. FIGS. 6a and 6b demonstrate the dual functionality of transmission and isolation in the case of a polarization beam combiner. The device receives two input beams from separate fibers as shown to the left in FIG. 6a. The first birefringent crystal moves the e-ray and the o-ray closer as shown by the output from crystal 1. The beams then pass through the half wave plate and the Faraday rotator where they get rotated by 45 degrees, i.e. at the output each of the two beams is rotated by 90 degrees and thus the e-ray is presented to the second birefringent crystal as an o-ray and the o-ray is presented to the second birefringent crystal as an e-ray. The second birefringent crystal then combines the e-ray and the o-ray by moving the two beams towards each other. FIG. 6b shows the reverse path for this device wherein the device prevents the beam of light from traveling in a reverse direction. On this reverse path, the common input beam is split into an e-ray and an o-ray by the second birefringent crystal. The e-ray and the o-ray then pass through the Faraday rotator and the half wave plate. Due to the non-reciprocal nature of the Faraday rotator the e-ray and the o-ray return to the same state of rotation at the output from the half wave plate as they were at the output from crystal 2. The first birefringent crystal then combines the e-ray and the o-ray in a position away from either one of the two input ports shown in FIG. 6a and thus isolating them. Alternatively, the direction of the magnetic field of the device is reversed so that it becomes a polarization beam splitter separating an input beam of light from one common fiber into two output beams of orthogonal polarization and, in addition, blocking light in a backward direction analogously as it was explained above for the case of the polarization beam combiner having isolation in a reverse direction.

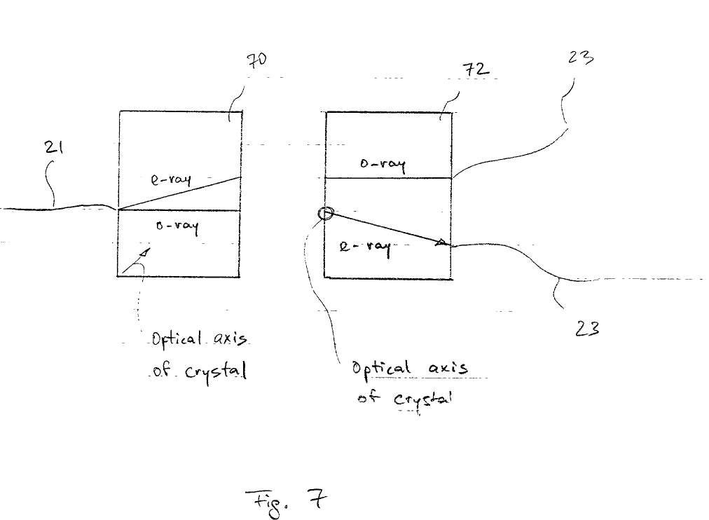

FIG. 7 shows yet a further embodiment of the polarization beam splitter/combiner in accordance with the present invention wherein a first uniaxial beam splitter/combiner in the form of a birefringent crystal 70 and a second uniaxial beam splitter/combiner in the form of a birefringent crystal 72 of equal length are directly coupled. In this embodiment the optical axis of the second birefringent crystal 72 is rotated by 90 degrees with respect to the optical axis of the first birefringent crystal 70 as can be seen from FIG. 7 wherein the optical axis of crystal 70 is disposed in the plane of the page, and the optical axis of crystal 72 is coming out of the plane of the page. By appropriately orienting the birefringent crystals 70 and 72 the o-ray path of the second birefringent crystal 72 is optically coupled with the e-ray path of the first birefringent crystal 70 and the e-ray path of the second birefringent crystal 72 is optically coupled with the o-ray path of the first birefringent crystal 70, and thus the separation between the two output fibers is matched. Advantageously, as can be seen from FIG. 7, the use of a rotator is not needed in this embodiment to yield a polarization beam splitter/combiner having equal path lengths.

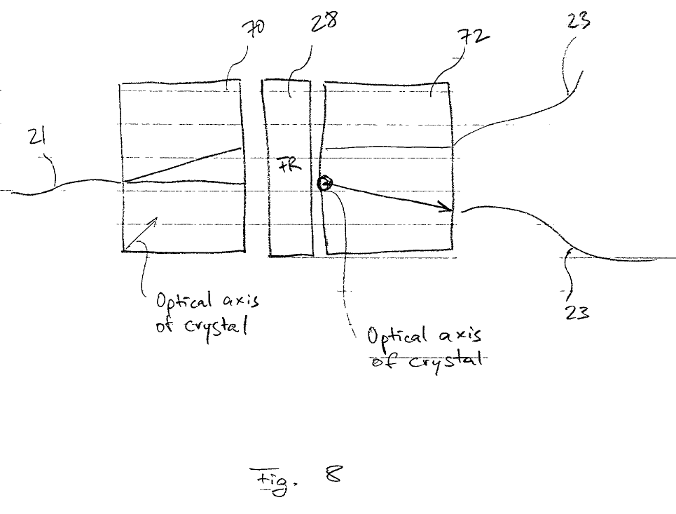

Analogously to the embodiment described in FIGS. 6a and 6b, isolation is provided to this embodiment by separating the two birefringent crystals 70 and 72 by a Faraday rotator as shown in FIG. 8. The Faraday rotator rotates a beam of light by 45 degrees in order to provide the dual functionality of transmission in a forward direction of the device and isolation in a reverse direction.

The devices presented in FIGS. 5a, 5b, 5c, 7, and 8 are shown to have polarization maintaining fiber 23 optically coupled to the two ports at one side of the device. On the other side of the device, a fiber 21 is optically coupled to the device. Depending on the application in which the device in accordance with the invention is used, fiber 21 is a regular fiber or a polarization maintaining fiber. Polarization maintaining fiber may be used at fiber 21, for example, to employ a phase difference of the combined orthogonally polarized beams to achieve a mixed polarization output.

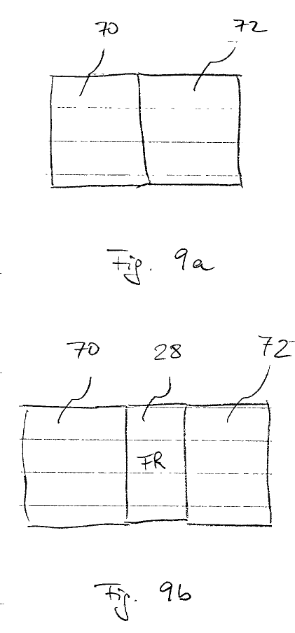

FIGS. 9a and 9b show a side view of the devices presented in FIGS. 7 and 8, respectively. Analogously to the embodiments presented in FIGS. 4a and 4b, the crystals 70 and 72 contact each other, as shown in FIG. 9a, or are adjacent to and contact the Faraday rotator 28 sandwiched between them, FIG. 9b, by applying a light transmissive adhesive between the contacting surfaces.

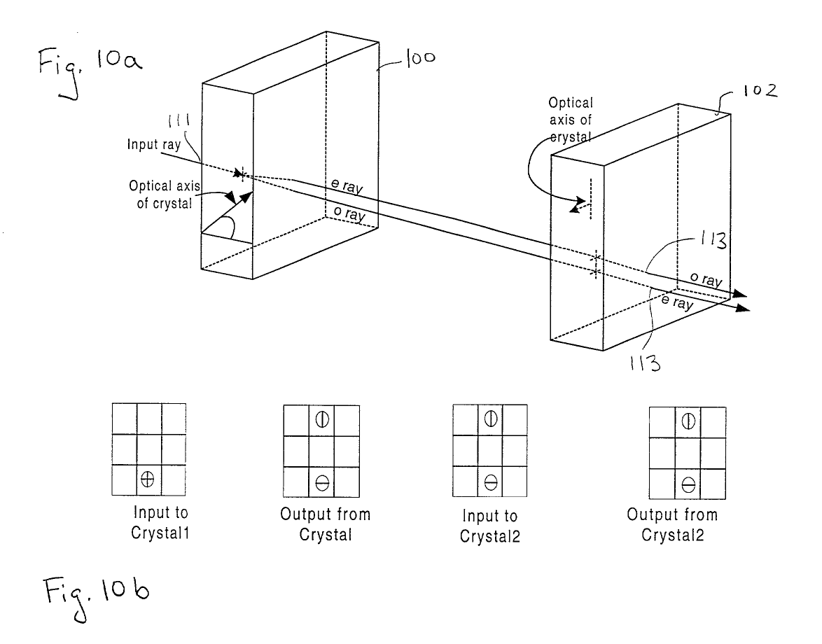

FIG. 10a shows an alternative embodiment of the invention wherein a uniaxial crystal in the form of a birefringent rutile crystal 100 is optically coupled with a second uniaxial crystal 102. Crystal 100 splits the ordinary and extraordinary rays. The second crystal 102 has an optical axis cut at zero degrees (in the plane of the face of the crystal) and aligned in such a manner that the ordinary ray sees the extraordinary index of refraction of the crystal 102 and the extraordinary ray sees the ordinary index of refraction of the crystal 102. The drawing is labelled to reflect the type of ray seen by the crystals. At the end of the second crystal the optical path length followed by the two rays is equivalent. The second crystal 102 acts a retarder to equalize the optical path length. The thickness of the first crystal 100 is determined by the direction of the optical axis of the first crystal 100 and the materials of the first and second crystals 100, 102. The materials may be different in the different crystals 100, 102, for instance YVO₄ and rutile.

FIG. 10b shows the polarization state and position of the principal rays passing through the polarization beam splitter/combiner. The input to the first crystal 100 at port 111 shows mixed polarization. The orthogonal polarizations are split by the first crystal 100 and input without rotation into the second crystal 102. In this embodiment, the separation is determined by the selection of material and dimension of the first crystal 100. The second crystal 102 provides equalization of the optical paths. The output of crystal 102 still has the same polarization, but the o-ray was passed through the second crystal 102 at an angle to the axis of the crystal to see the extraordinary index of refraction, and the e-ray to see the ordinary index of refraction of the crystal. Hence the o-ray has been retarded more that the e-ray to equate the optical path lengths.

Numerous other embodiments can be envisaged without departing from the spirit and scope of the invention which is defined in the claims. For instance path length equalization can be achieved through the use of additional glass block to increase the path length of one sub-beam, or the ends of the output fibers can be physically positioned in different planes.

What is claimed is:

1. A polarization beam splitter/combiner comprising:
a first port for launching a beam of light into the polarization beam splitter/combiner in a forward direction or for receiving a beam of light from the polarization beam splitter/combiner in a reverse direction;
a first uniaxial crystal having an o-ray path and an e-ray path and having the first port optically coupled to an end face thereof;
a second uniaxial crystal having an e-ray path and an o-ray path such that the e-ray path of the second uniaxial crystal is optically coupled with the o-ray path of the first uniaxial crystal and the o-ray path of the second uniaxial crystal is optically coupled with the e-ray path of the first uniaxial crystal; and
a second and a third port optically coupled to an end face of the second uniaxial crystal for one of receiving a first beam of a first polarization state and a second beam of a second orthogonal polarization state in the forward direction and for launching the first beam of the first polarization state and the second beam of the second orthogonal polarization state into the polarization beam splitter/combiner in the reverse direction, each of the second and the third ports being optically coupled with a polarization maintaining waveguide,
wherein the first beam of the first polarization state and the second beam of the second orthogonal polarization state have a substantially same optical path length.

2. A polarization beam splitter/combiner as defined in claim 1, wherein the first uniaxial crystal and the second uniaxial crystal are optically coupled to provide equal optical and physical path lengths.

3. A polarisation beam splitter/combiner as defined in claim 1, wherein an axis of the second crystal is aligned in such a manner that the o-ray path is retarded by an extraordinary index of refraction of the crystal and the e-ray path is retarded by an ordinary index of refraction to equalize the optical path lengths.

4. The polarization beam splitter/combiner as defined in claim 1 further including a polarization rotator between the first uniaxial crystal and the second uniaxial crystal for rotating the polarization of light received from the first uniaxial crystal in a forward direction or for rotating the polarization of light received from the second uniaxial crystal in a reverse direction.

5. The polarization beam splitter/combiner as defined in claim 4 wherein the polarization rotator is a reciprocal rotator.

6. The polarization beam splitter/combiner as defined in claim 5 wherein the reciprocal rotator is a half waveplate.

7. The polarization beam splitter/combiner as defined in claim 6 wherein the half waveplate is for rotating the polarization of light incident thereon by 90 degrees.

8. The beam splitter/combiner as defined in claim 4 wherein the polarization rotator is adjacent and contacting the first and the second uniaxial crystal.

9. The polarization beam splitter/combiner as defined in claim 6 wherein an optical axis of the half waveplate is oriented at approximately 45 degrees to birefringent axes of the first and second uniaxial crystal.

10. The polarization beam splitter/combiner as defined in claim 9 wherein the optical axis of the half waveplate is oriented at approximately 45° to the polarization of light incident thereon from the first uniaxial crystal.

11. The polarization beam splitter/combiner as defined in claim 1 further including a non-reciprocal polarization rotator for providing isolation in a reverse direction.

12. The polarization beam splitter/combiner as defined in claim 1 1 wherein the non-reciprocal polarization rotator is a Faraday rotator.

13. The polarization beam splitter/combiner as defined in claim 11 wherein the non-reciprocal polarization rotator is driven in an opposite direction for providing isolation in a forward direction.

14. The polarization beam splitter/combiner as defined in claim 5 further including a non-reciprocal polarization rotator for providing isolation in a reverse direction.

15. The polarization beam splitter/combiner as defined in claim 14 wherein the non-reciprocal polarization rotator is a Faraday rotator.

16. The polarization beam splitter/combiner as defined in claim 14 wherein the non-reciprocal polarization rotator is driven in an opposite direction for providing isolation in a forward direction.

17. The polarization beam splitter/combiner as defined in claim 1 wherein the uniaxial crystals are made from materials including rutile (TiO₂), yttrium vanadate (YVO₄), magnesium fluoride (MgF₂), quartz (SiO₂), lithium niobate (LiNbO₃), and calcite (CaCO₃).

18. The polarization beam splitter/combiner as defined in claim 1, wherein the first and the second uniaxial crystal are substantially of a same length.

19. The polarization beam splitter/combiner as defined in claim 1 wherein the first port is optically coupled with a polarization maintaining waveguide.

20. A polarization beam splitter/combiner comprising:
a first port for one of launching a beam of light into the polarization beam splitter/combiner in a forward direction and for receiving a beam of light from the polarization beam splitter/combiner in a reverse direction;
a first uniaxial crystal having an o-ray path and an e-ray path and having the first port disposed at an end face thereof;
a second uniaxial crystal having an o-ray path and an e-ray path, the e-ray path of the second uniaxial crystal being optically coupled with the o-ray path of the first uniaxial crystal and the o-ray path of the second uniaxial crystal being optically coupled with the e-ray path of the first uniaxial crystal; and
a second and a third port disposed at an end face of the second uniaxial crystal for one of receiving a first beam of a first polarization state and a second beam of a second orthogonal polarization state in the forward direction and for launching the first beam of the first polarization state and the second beam of the second orthogonal polarization state into the polarization beam splitter/combiner in the reverse direction, each of the second and the third ports being optically coupled with a polarization maintaining waveguide,
wherein the first beam of the first polarization state and the second beam of the second orthogonal polarization state have a substantially same optical path length, and wherein output/input sub-ports at the o-ray path and the e-ray path of the first uniaxial crystal have a separation “d1” and wherein the second and the third port of the second uniaxial crystal have a separation “d2” which is substantially greater than “d1”.

21. The polarization beam splitter/combiner as defined in claim 20 wherein “d1” is substantially equal to “d2/2”.
